(19) United States
(12) Patent Application Publication
(10) Pub. No.: US 2003/0198143 A1
(43) Pub. Date: Oct. 23, 2003

(54) Energy saving device

(76) Inventor: Yuji Kohara, Hiroshima (JP)

Correspondence Address: BIRCH STEWART KOLASCH & BIRCH, PO BOX 747, FALLS CHURCH, VA, 22040-0747, US

(21) Appl. No.: 10/192,562

(22) Filed: Jul. 11, 2002

(30) Foreign Application Priority Data
Apr. 22, 2002 (KR) 2002-21885

(51) Int. Cl. G04B 1/00; G04C 3/00

(52) U.S. Cl. 368/204

(57) ABSTRACT

An energy saving device includes a high voltage power source, a direct current gate and and exchange gate for separating a pair of direct current gages in the same as voltage, amperage and watt of the direct current gate by electric discharging of switching pulse.

### BACKGROUND OF THE INVENTION

1. Field of the Invention

The present invention relates to an energy saving device, and more particularly, to an improved energy saving device for effective saving energy by separating direct current (hereinafter “DC”) energy at exchange gates causing electric discharge of a switching pulse at an exchange gate thereof.

2. Description of Related Art

Various types of energy saving devices are known in the art. Recently, many people have tried to create improved energy saving devices in a lot of studies. However, it is hard to get the energy saving devices in economy since even though several devices generating electricity have existed, there are no desired devices for saving electricity.

Generally, the electric energy is generated by a hydroelectric generation, an atomic power generation, a thermal power generation, a wind force power generation, a chemical power generation, and a solar heated power generation. However, the electric energy after generating through the above power generations does not succeed to save the electric energy.

### SUMMARY OF THE INVENTION

Accordingly, it is an object of the present invention to provide an improved energy saving device for separating DC energy which eliminates the above problems encountered with conventional energy saving devices for separating DC energy.

Another object of the present invention is to provide an energy saving device which includes a high voltage power source for producing alternating current energy, a direct current gate for charging to DC energy from the alternating current energy of the high voltage power source, and an exchange gate for receiving the DC energy from the direct current gate so as to separate the DC energy at the exchange gate by electric discharging of a switching pulse, whereby the electric energy can be effectively saved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagrammatic view of an energy saving device according to the present invention;

### DETAILED DESCRIPTION OF THE PREFERRED EMBODIMENTS

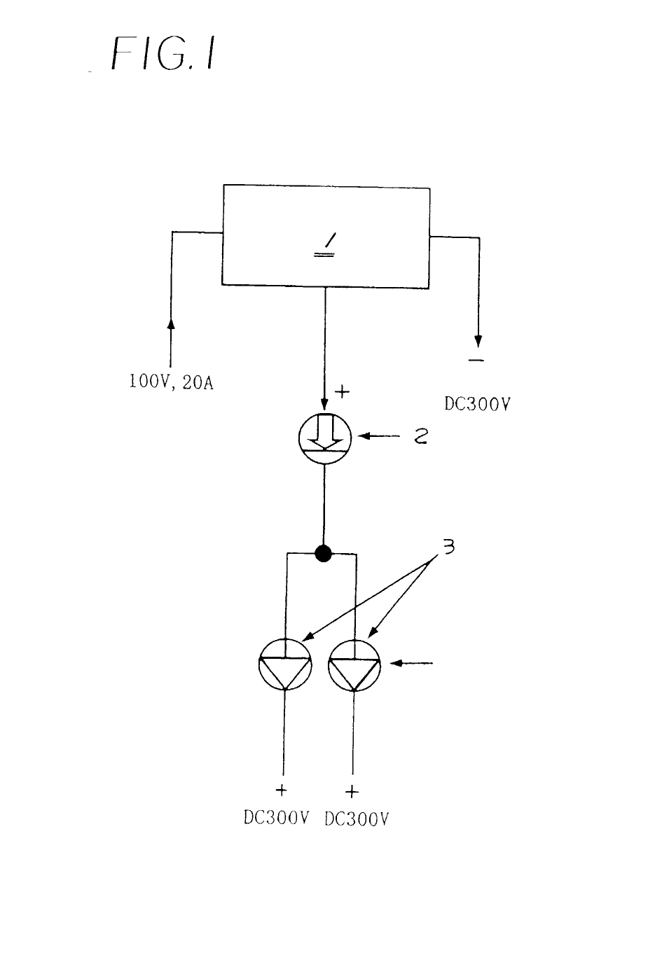

Referring now in detail to the drawings for the purpose of illustrating preferred embodiments of the present invention, the energy converting saving device as shown in FIG. 1 includes a high voltage power source 1, a direct current gate 2 connected with the high voltage power source 1, and an exchange gate 3 connected with the direct current gate 2. At this time, the high voltage power source 1 has 100 voltage, 20 amperage, and 100 watt.

The alternating current energy (hereinafter “AC”) from the high voltage power source 1 conducts to the direct current gate 2 for producing DC energy. At this time, by electric discharging of switching pulse, the DC energy of 300 voltage is separated at the pair of exchanging gates 3 wherein each exchanging gate 3 has 300 voltage DC energy. That is, DC energy of each exchange gate 3 has 300 voltage, 20 amperage and 100 watt.

Accordingly, the energy saving device according to the present invention can save 50% of a conventional electric consumption amount for use in electric home appliances, and electric industrial goods. The pair of exchange gates 3 can be exchanged each other by transistor or the like. The switching pulse transforming function of the present invention can be changed if necessary, so long as the energy saving device of the present invention can be saved electric energy extremely. Also, when the energy saving device of the present invention is utilized to a transistor, a diode, and a power transformer, the electricity can be supplied effectively. If the energy saving device according to the present invention is utilized to a four wheel electric automobile, and a hybrid electric automobile, the electricity can be saved and continued ratio can be improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An energy saving device comprising:
a high voltage power source;
a direct current gate connected to said high voltage source for conducting alternating current from the high voltage power source, said direct current gate being able to direct current from the alternating current of the high voltage power source; and
a pair of exchanging gates connected to the direct current gate and separated from the direct current gate in the same as voltage, amperage and watt of the direct current of the direct current gate by electric charging of switching pulse thereof.

2. The energy saving device of claim 1, wherein said high voltage power source has 100 voltage and 20 amperage.

3. The energy saving device of claim 1, wherein said direct current gate has DC 300 voltage.

4. The energy saving device of claim 1, wherein each exchanging gate has the same as voltage, amperage and watt of the direct current gate of DC 300 voltage.
